(19) United States
(12) Patent Application Publication
(10) Pub. No.: US 2006/0078698 A1
(43) Pub. Date: Apr. 13, 2006

(54) Nursery container labeling system

(75) Inventor: John Silvestri, Chambersburg, PA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Nursery Supplies, Inc., Chambersburg, PA (US)

(21) Appl. No.: 11/194,268

(22) Filed: Aug. 1, 2005

Related U.S. Application Data
(60) Provisional application No. 60/598,252, filed on Aug. 3, 2004.

(51) Int. Cl. B31B 45/00

(52) U.S. Cl. 428/34.1; 428/203

(57) ABSTRACT

The present invention includes a label for a nursery container. The label includes a protective first layer having a first adhesive layer affixed to at least a portion of a second side of the protective first layer. The label also includes a second layer having a top surface and a bottom surface, the top surface contacting at least a portion of the first adhesive layer. The label further includes a base adhesive layer having a first side and a second side, the first side affixed to at least a portion of the bottom surface of the second layer and the second side of the base adhesive affixed to the container. In addition, at least a portion of the first adhesive layer is affixed to the container. A method for creating the label is also defined.

### FIELD OF THE INVENTION

The present invention relates to a labeling system for nursery containers and similar growing containers and, more particularly, to a multi-layer labeling that is removable from the container.

### BACKGROUND

Nursery containers traditionally have served a single primary purpose—to provide a mechanism for growing and transporting a plant. As such, nursery owners using the container paid little attention to details of the container. As long as the container was priced appropriately and could survive a growing season, the nursery owner would purchase the container.

In recent years, uses for nursery containers have grown. For example, in and above ground plant growing systems have led to the use of containers to grow larger plants, including trees, that were previously grown directly in the ground. As such, the containers have been modified to last longer, as well as designed to accommodate larger and heavy plants. For example, U.S. Pat. No. 5,503,886 to Guarriello, et al., describes an innovative blow molded container with a rim designed to provide structural rigidity with cushioning. Also for example, the container, sold by Nursery Supplies, Inc., Chambersburg, Pa., under the trademark GRIP-LIP®, permits larger and heavier loads to be carried in the container.

Although innovations have been made in recent years to the containers, one of the areas that has not achieved much attention has been in labeling of the containers. As noted above, containers have typically been considered throw away items and, as such, have not been considered as being anything but temporary carriers. As a result, placement of labeling on the containers has been limited to simply applying stickers to the container, such as stickers that identify the plant or include the nursery owner's or container manufacturer's name on it. If the label includes the manufacturer's name, it is usually removed by the nursery owner before the nursery owner displays the product. If the label includes the nursery owner's name, it is generally not removed by the end user because the end user will generally discard the container after the plant is removed.

Another form of labeling that is currently being used is the application of labeling ink (i.e., paint) directly to the container. Because this form of labeling is permanent, generally only the name of the nursery owner is applied with this form of label. The problem with this permanent form of labeling is that it is typically applied by the container manufacturer. As such, the manufacturer must manufacture and store the labeled containers separately from containers for other customers. This can lead to logistical problems.

As described above, it is now common for containers to be left in the growing fields for more than one growing season. Typically plants are grown for three or more years before they are sold. In the growing fields, the containers are exposed to a variety of weather conditions and chemicals. As a result, any label that is placed on the container would quickly become weathered and damaged, detracting from its marketing ability.

Thus, an improved labeling system is needed that can withstand weather and chemicals while still providing the marketing required by nurseries.

### SUMMARY OF THE INVENTION

One embodiment of the present invention is a label for a nursery container. The label includes a protective first layer having a first side and a second side. A first adhesive layer is affixed to at least a portion of the second side of the protective first layer. The label also includes a second layer having a top surface and a bottom surface, the top surface contacting at least a portion of the first adhesive layer. The label also includes a base adhesive layer having a first side and a second side, the first side affixed to at least a portion of the bottom surface of the second layer and the second side of the base adhesive affixed to the container. In addition, at least a portion of the first adhesive layer is affixed to the container.

Another embodiment of the present invention includes a method of making a label for a nursery container. The method includes providing a first material and a second material. A first adhesive is applied to the first material to form a protective first layer. A top or bottom surface of the second material is reverse printed and a base adhesive is applied to the bottom surface of the second material. The second material is then die cut into a desired shape to form a second layer. The second layer is registered with the first layer. Finally, the first layer is die cut, leaving the first layer on top of the second layer to form the label.

### BRIEF DESCRIPTION OF THE DRAWINGS

For the purpose of illustrating the invention, there is shown in the drawings various forms which are presently disclosed; it being understood, however, that this invention is not limited to the precise arrangements and instrumentalities particularly shown.

FIG. 1 is a perspective view of a nursery container having a label of the present invention.

FIG. 2 is a perspective view of a nursery container having a label of the present invention.

FIG. 3 is a perspective view of a nursery container having a label of the present invention.

FIG. 4 is a perspective view of a nursery container having a label of the present invention being peeled off of the container.

FIG. 5 is a cross-section view of a label of the present invention.

FIG. 5A is a cross-section view of a layer of the label of the present invention.

FIG. 6 is a schematic detailing a method for making a label of the present invention.

### DETAILED DESCRIPTION OF THE INVENTION

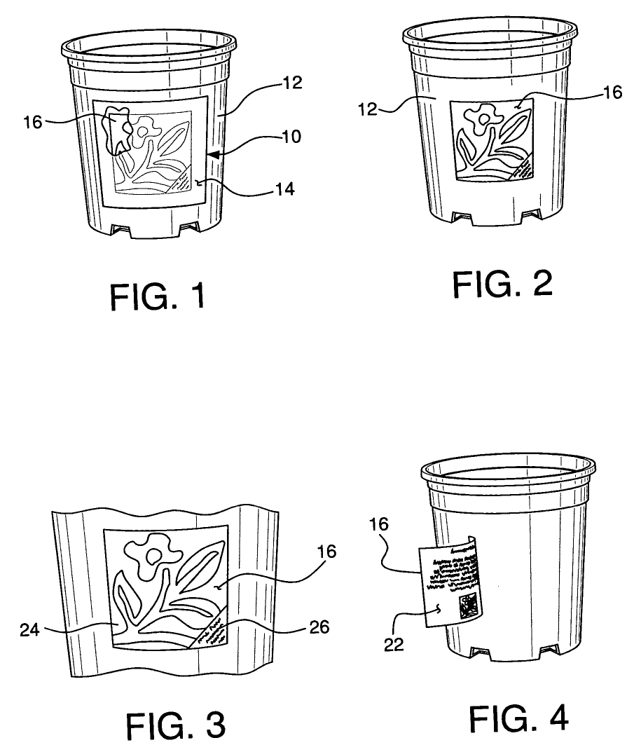

Referring to FIGS. 1-5, an embodiment of a label 10 according to the present invention is shown on a nursery container 12. The label includes a protective first layer 14 and a second label layer 16. The second layer 16 is preferably removably adhered to the container 12. The first layer 14 overlays the second layer 16 and is removably adhered to the container 12 and/or the second layer 16. As shown, the first layer 14 is larger than the second layer 16. However, the first layer 14 can have the same or smaller dimensions than the second layer 16.

More particularly, the first layer 14 is made from a material that prevents or minimizes water or other environment/chemical seepage through the layer (e.g., is a moisture and chemical barrier or inhibitor). In one embodiment, the first layer 14 is made from a polyester material. Preferably the material is opaque or semi-transparent (translucent) so as to provide differentiation from the second layer 16. This provides some degree of assurance that the first layer 14 will not be inadvertently left on the second layer when sold by the nursery owner. It is also preferable that the first layer permit writing on it, such as with a marker. This gives the nursery owner or the container manufacturer the ability to mark the label without damaging the second layer.

A material suitable for the first layer is Fasson® 2 Mil White Polyester TC/S730/50# SCK ABC, sold by Fasson Roll North America. This material is a white facestock with good tear strength, heat resistance, dimensional stability, opacity and chemical resistance.

While the figures illustrate an opaque layer with no markings on it, it is also contemplated that the first layer may include printing, such as the manufacturer's name, or indicia that assists in tracking/inventorying the container (e.g., bar coding).

The second layer 16 is designed to provide the labeling. As such, the second layer 16 is preferably made from a material that can accept printing. One preferred label material is Fasson® 1 Mil Clear Polyester TC/S730/50# SCK ABC. This material is a transparent film with good tear strength, heat resistance, dimensional stability and chemical resistance. This material is also designed for printing with most solvent and some water-based flexographic inks.

The labeling system of the present invention requires that the first layer 14 be removable so as to permit viewing of the second layer 16. Thus, the first layer 14 must be attached to the container 12 and/or the second layer 16 in a manner that would permit the first layer 14 to be easily removed without removing the second layer 16. This is accomplished through the use of a first adhesive layer 18, which will be discussed in more detail below.

The second layer 16 is attached to the container 12 with a base adhesive 20. Since the second layer 16 is likely to be removed from the container by the end user and thus is not likely to be subject to frequent growing seasons, the adhesive need only last until the container 12 is sold to the end user. While the second label 16 may be made to stay permanently on the container, it is preferable that the base adhesive 20 permits the second label 16 to be removed from the container 12 at some point after sale to the end user.

While a nursery owner prefers to include a label on its container when it is sold, the nursery owner would prefer that the label is removed by the end user after the container is sold. As our society becomes more and more conscience of the benefits of recycling, it also becomes more conscience of companies and individuals that do not do their part in the recycling effort. Once a container leaves a nursery, the nursery owner has no control over the container. Hence, while the nursery owner may be environmentally conscious and an advocate of recycling, the end user of the product in the container may not be. If the end user tosses a container into the trash with the nursery owner's company logo on it, people who see the container naturally think negatively of the nursery owner's recycling habits even though the nursery owner had nothing to do with the container being discarded.

The present invention addresses this problem by selecting a base adhesive 20 that permits the second layer 16 to be removed. Most nursery containers are made from polyethylene material which has natural oils in it. As such, a permanent adhesive can be used as the base adhesive 20 to attach the second label 16 to the container 12. The natural oils reduce the permanence of the permanent adhesive, thus permitting the second label 16 to be removed relatively easily. One preferred form of permanent adhesive is S730 adhesive. S730 adhesive is a clear adhesive featuring good initial tack, high shear, minimal cold flow and will adhere to a wide variety of substrates.

However, as should be apparent, the choice of adhesive will depend on several factors, including the container material and the label material. It is contemplated that pressure sensitive materials (e.g, pressure sensitive adhesives) can also be used.

In order to encourage the end user to remove the second layer, it is preferable to include planting instructions that are visible from the inside surface 22 of the second layer 16. The outside surface 24 could include a form of indicia 26 informing the purchaser that the reverse side includes important information. Once the user pulls off the second layer 16, it will likely be discarded.

As discussed above, the protective first layer 14 is attached to the container and/or the second layer 16 so as to be removable without removing the second layer 16. The degree of adhesion of the first layer 14 to the container 12 and/or the second layer 16, should be less than the adhesion provided by the base adhesive 20. This can be achieved by selecting an adhesive for use as the first adhesive 18 that has less adhesive strength than the base adhesive 20.

Alternately, if the first layer 14 is adhered to only the container 12 and not the second layer 16, then any suitable type of adhesive can be used. For convenience, the first adhesive 18 can be the same as the base adhesive 20. There are various ways to prevent the first adhesive 18 from adhering to the second layer 16, such as coating the second layer 16 with a release layer 19, pattern applying the first adhesive 18 such that the first adhesive is not present on the portion of the first layer 14 that overlays the second layer 16, or deadening the first adhesive 18, such as with a varnish, in the area overlaying the second layer 16. Those skilled in the art would be readily capable of configuring the first adhesive 18 in light of the teachings provided herein.

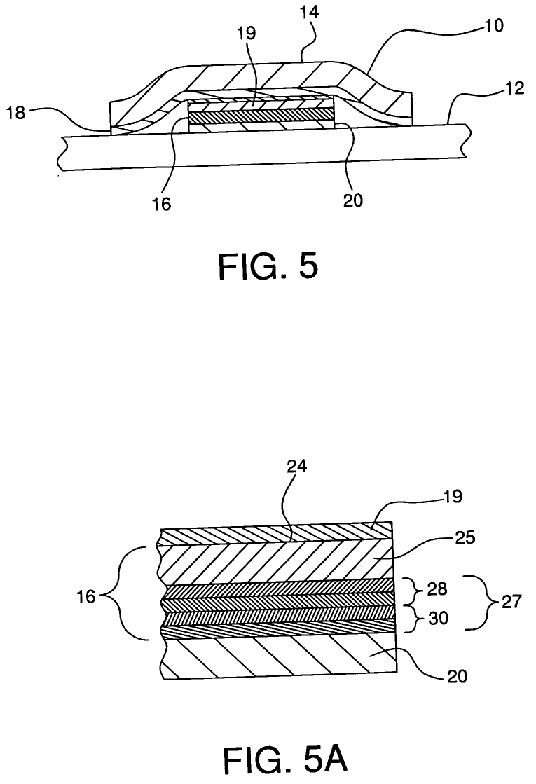

Referring to FIG. 5A, the second layer includes a transparent polyester layer 25, and at least one print layer 27, which can be applied through reverse printing. Preferably there are a plurality of print layers 28, 30. At least one layer 28 includes printing that forms the image and/or text that is visible on the outside surface 24 of the second layer 16. This may be, for instance, the ink that forms the nursery owner's logo or other marketing information.

At least one layer 30 includes printing that forms the image and/or text that is visible on the inside surface 22 of the second layer 16. This may be, for instance, the ink that forms the instructions for planting.

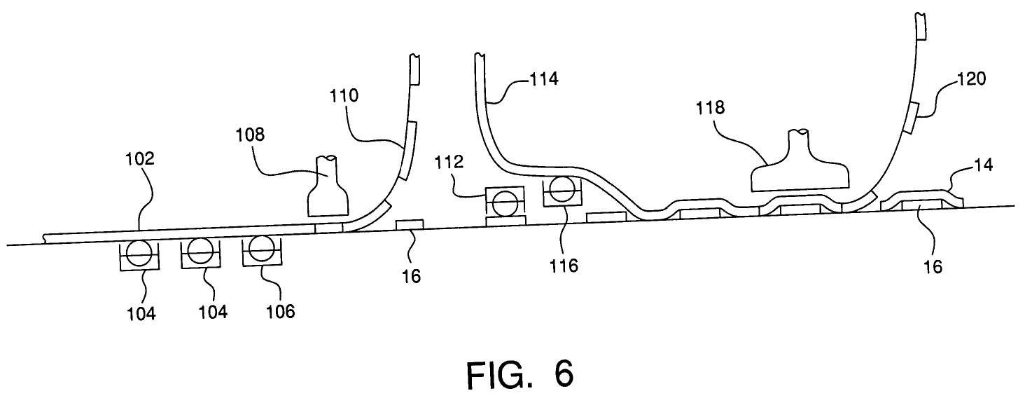

Referring now to FIG. 6, a schematic representation of the process 100 for forming the label 10 in accordance with one embodiment of the invention is shown. The process involves transferring the material 102 that forms the second layer 16 on a carrier through the reverse printing application stages 104. The formation of reverse printing on a substrate is well known in the printing art and, thus, no further details are necessary. The second layer material 102 is then transferred through a stage 106 where the base adhesive 20 is applied. The material 102 is then transferred through a die cutting station 108 where the shape of the second layer 16 is cut from the material 102. The remaining matrix 110 of the material 102 is removed and discarded.

If a release layer 19 is applied between the first and second layers 14, 16, it may be applied 112 to the outside surface of the second layer 16. The release characteristics can be from chemical release properties and/or mechanical release properties. Migratory, non-migratory, and reacted-in slip agents provide chemical release properties to the release layer. Examples of slip agents include acids, esters, fatty acid amines, and natural wax. Inorganic additives can provide mechanical release properties to the release layer. Examples of inorganic additives include calcium carbonate, synthetic silica, synthetic clay, talc, zeolite, and ceramic and glass spheres.

The material 114 that forms the first layer 14 is transferred past an adhesive application station 116 where the first adhesive 18 is applied. If, instead of a release layer being applied between the first and second layers 14, 16 the adhesive is deadened, then the material 114 is transferred through a deadening station (not shown), where an adhesive deadening agent is added to the adhesive layer 18 in the region which overlies the second layer 16. Examples of suitable adhesive deadening agents include silicone and paraffin.

The material 114 is next brought into register with the second layer 16 and the combination is transferred through a second die cutting station 118 which cuts the first layer 14 from the material 114. The matrix 120 of material 114 is removed and discarded, leaving the first layer 14 on top of the second layer 16. The carrier then is either wound in combination with the labels 10 for storing the labels 10 for later use, or transfers the labels 10 to an application station where the labels 10 are applied to a nursery container.

In an alternate embodiment of the invention, the second layer 16 is applied to the container 12 during the container molding process using an in-mold labeling system. In-mold labeling systems are well known in the art. As such, a detailed discussion is not necessary. Generally, the process involves placing a label on the inside surface of the mold and then molding the product such that the moldable material forming the product surface adheres with the label. In the present case, the second layer 16 is placed within the mold against the mold inner surface. A parison of plastic is extruded into the mold and blown against the mold surfaces using a conventional blow molding method. The second label adheres to the surface of the container 12.

Once the container 12 is released from the mold, the protective first layer 14 is applied over the second layer 16. As described above, the first layer 14 can adhere to the second layer 16 or the container 12. Due to the relatively rigid adherence of the second layer to the container using the in-mold processing, a variety of adhesives can be used as the first adhesive 18.

In this embodiment of the invention, the second layer (i.e., the printed label) is preferably made from a multilayer plastic material or a high-density polyethylene fibrous material, such as TYVEK® material. TYVEK is a registered trademark of DuPont Company, Wilmington, Del. Alternate materials can be used. The materials would be selected based on the container material. Those skilled in the art of labeling would readily appreciate the diverse materials that can be used to form a second layer for adherence to a nursery container using an in-mold labeling process.

One of the benefits of this embodiment of the invention is that a base adhesive layer is not necessary for adhering the second layer to the container. Instead, the molding process itself results in the adherence of the second layer.

The above describes two alternate methods for forming a label in accordance with the present invention. Those skilled in the art would readily appreciate that various modifications can be made to these processes without departing from the scope of the invention. For example, the base adhesive can be applied after the first and second layer are brought into registry with one another.

It will be appreciated by those skilled in the art that the present invention may be practiced in various forms and configurations. The previously detailed description of the disclosed embodiments is presented for purposes of clarity of understanding only, and no unnecessary limitations should be implied therefrom.

What is claimed is:

1. A label for a nursery container, the label comprising:
a protective first layer having a first side and a second side;
a first adhesive layer affixed to at least a portion of the second side of the protective first layer;
a second layer having a top surface and a bottom surface, the top surface of the second layer contacting at least a portion of the first adhesive layer; and
a base adhesive layer having a first side and a second side, the first side affixed to at least a portion of the bottom surface of the second layer and the second side of the base adhesive affixed to the container;
wherein at least a portion of the first adhesive layer is affixed to the container.

2. A label according to claim 1 wherein the second layer comprises a first print layer visible through the top surface of the second layer and a second print layer visible through the bottom surface of the second layer.

3. A label according to claim 1 having a release layer coating at least a portion of the top surface of the second layer.

4. A method for making a label for a nursery container, the method comprising:
providing a first material and a second material;
applying a first adhesive on a second side of the first material to form a protective first layer;
reverse printing on a top or bottom surface of the second material;
applying a base adhesive to the bottom surface of the second material;
die cutting the second material into a desired shape to form a second layer;
registering the second layer and the first layer, with the top surface of the second layer contacting the second side of the first layer; and
die cutting the first layer, leaving the first layer on top of the second layer to form the label.
